(19) United States
(12) Patent Application Publication
(10) Pub. No.: US 2026/0062769 A1
(43) Pub. Date: Mar. 5, 2026

(54) METHOD OF LEACHING NICKEL FROM OXIDIZED ORE, METHOD OF MANUFACTURING NICKEL SULFATE, AND NICKEL-LEACHING AGENT

(71) Applicants: Prime Planet Energy & Solutions, Inc., Tokyo (JP); KYUSHU UNIVERSITY, NATIONAL UNIVERSITY CORPORATION, Fukuoka-ken (JP); TOYOTA TSUSHO CORPORATION, Aichi-ken (JP); TOYOTA JIDOSHA KABUSHIKI KAISHA, Aichi-ken (JP)

(72) Inventors: Yuji YAMAMOTO, Toyota-shi (JP); Masahiro GOTO, Fukuoka-shi (JP); Mayu KAMISONO, Fukuoka-shi (JP); Hayate SATO, Fukuoka-shi (JP); Takeru MORIYAMA, Nagoya-shi (JP); Momoko PROCTER, Seto-shi (JP)

(21) Appl. No.: 19/309,621

(22) Filed: Aug. 26, 2025

(30) Foreign Application Priority Data
Aug. 27, 2024 (JP) 2024-145974

(51) Int. Cl. C22B 3/00; C01G 53/10; C22B 3/10

(52) U.S. Cl. CPC C22B 23/0423; C01G 53/10; C22B 3/10

(57) ABSTRACT

Provided is a method capable of selectively leaching Ni from an oxidized ore containing Ni and Si. The method of leaching nickel from an oxidized ore according to the present disclosure includes the steps of: preparing a liquid leaching agent containing a hydrogen bond acceptor that has made contact with hydrochloric acid, and a hydrophobic organic compound (provided that unsubstituted alicyclic hydrocarbon compounds and unsubstituted aromatic hydrocarbon compounds are excluded); and contacting an oxidized ore containing nickel and silicon with the leaching agent.

### CROSS REFERENCE TO RELATED APPLICATION

The present application claims priority to Japanese Patent Application No. 2024-145974, filed on Aug. 27, 2024, the entire contents of which are incorporated herein by reference.

### BACKGROUND OF THE DISCLOSURE

### 1. Field

The present disclosure relates to a method of leaching nickel from an oxidized ore containing nickel (Ni) and silicon (Si) into a leaching agent. The present disclosure also relates to a method of manufacturing nickel sulfate using the above method. The present disclosure further relates to a leaching agent for leaching nickel from an oxidized ore containing nickel (Ni) and silicon (Si).

### 2. Background

In recent years, there is an ever increasing demand for lithium-ion secondary batteries. Ni-containing materials such as lithium-nickel-cobalt-manganese based composite oxides and lithium-nickel-cobalt-aluminum based composite oxides are often used as cathode active materials of lithium-ion secondary batteries. Meanwhile, Ni is also used in stainless steels, specialty steels, and the like. There are also increasing demands for these products. Consequently, the demand for Ni is increasing rapidly, and methods of obtaining Ni sources (particularly, nickel sulfate) are becoming increasingly important.

As an example of a method of obtaining a Ni source, known is a leaching method of leaching Ni from an Ni-containing oxidized ore using an acid-containing leaching agent. For example, Japanese Patent Application Laid-Open No. 2023-119164 proposes the use of an organic phase containing an organic acid and a hydrophobic deep eutectic solvent including an acidic hydrogen bond donor and a hydrogen bond acceptor, as a leaching agent. Nickel oxidized ore is then brought into contact with the organic phase to leach Ni into the organic phase.

### SUMMARY

However, metal components other than Ni may also be leached in the leaching methods. In particular, Si-rich nickel oxidized ore may suffer from a problem in which Si is leached along with Ni. Therefore, there is a desire to develop a method capable of selectively leaching Ni from an oxidized ore containing Ni and Si.

Accordingly, an object of the present disclosure is to provide a method capable of selectively leaching Ni from an oxidized ore containing Ni and Si.

A method of leaching nickel from an oxidized ore according to the present disclosure includes the steps of: preparing a liquid leaching agent containing a hydrogen bond acceptor that has made contact with hydrochloric acid, and a hydrophobic organic compound (provided that unsubstituted alicyclic hydrocarbon compounds and unsubstituted aromatic hydrocarbon compounds are excluded); and contacting an oxidized ore containing nickel and silicon with the leaching agent.

According to this configuration, Ni can be selectively leached from the oxidized ore containing Ni and Si

In another aspect, the nickel-leaching agent according to the present disclosure is a liquid nickel-leaching agent containing a hydrogen bond acceptor that has made contact with hydrochloric acid and a hydrophobic organic compound.

According to this configuration, Ni can be selectively leached from the oxidized ore containing Ni and Si

In another aspect, a method of manufacturing nickel sulfate according to the present disclosure includes the steps of: obtaining a nickel leachate by the method of leaching nickel from an oxidized ore as described above; and back-extracting the nickel leachate using sulfuric acid to obtain an aqueous phase containing nickel sulfate.

According to this configuration, Ni can be selectively leached from the oxidized ore containing Ni and Si, thereby finally obtaining nickel sulfate.

### BRIEF DESCRIPTION OF THE DRAWINGS

FIG. 1 shows a flowchart of the steps in a method of leaching nickel from an oxidized ore according to the present disclosure; and

FIG. 2 shows a flowchart of the steps in a method of manufacturing nickel sulfate according to the present disclosure.

### DETAILED DESCRIPTION OF THE EMBODIMENTS

Hereinafter, the embodiments according to the present disclosure will be described with reference to the drawings. It should be noted that matters which are not mentioned in the present specification, but necessary for implementing the present disclosure can be understood as design matters based on the conventional technology by those skilled in the art. The present disclosure can be implemented based on what are disclosed in the present specification and the technical common sense in the art. It should be noted that a numerical range expressed as “A to B” in the present specification includes A and B.

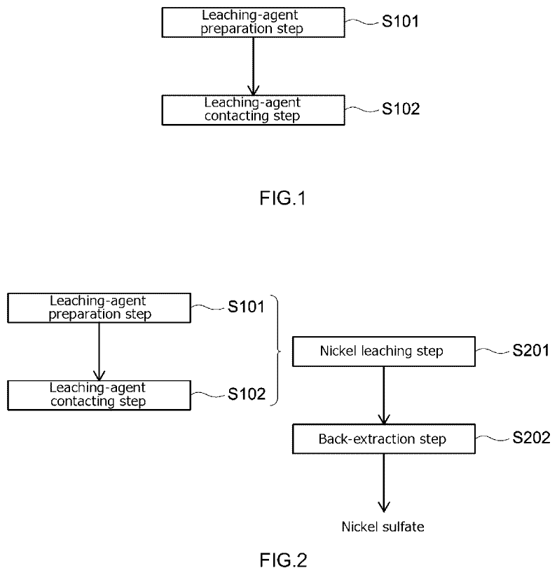

As shown in FIG. 1, the method of leaching nickel from an oxidized ore according to the present disclosure includes the steps of: preparing a liquid leaching agent containing a hydrogen bond acceptor that has made contact with hydrochloric acid, and a hydrophobic organic compound (provided that unsubstituted alicyclic hydrocarbon compounds and unsubstituted aromatic hydrocarbon compounds are excluded) (hereinafter may also be referred to as the “leaching-agent preparation step”) S101; and contacting an oxidized ore including nickel and silicon with the leaching agent (hereinafter may also be referred to as the “leaching-agent contacting step”) S102. As shown in FIG. 2, the method of manufacturing nickel sulfate according to the present disclosure utilizes the method of leaching nickel from an oxidized ore according to the present disclosure. The method of manufacturing nickel sulfate according to the present disclosure includes the steps of: obtaining a nickel leachate by the method of leaching nickel from an oxidized ore according to the present disclosure (hereinafter may also be referred to as the “nickel leaching step”) S201; and back-extracting the nickel leachate using sulfuric acid to obtain an aqueous phase containing nickel sulfate (hereinafter may also be referred to as the “back-extraction step”) S202. Hereinafter, these steps will be described in detail.

### <Leaching-Agent Preparation Step S101>

The leaching agent prepared in the leaching-agent preparation step S101 is in a liquid form. The leaching agent is only required to be in a liquid form at a temperature where leaching is performed (that is, a leaching temperature). The leaching agent is typically in a liquid form at 25° C. The above leaching agent contains a hydrogen bond acceptor that has made contact with hydrochloric acid, and a hydrophobic organic compound. However, the hydrophobic organic compound used in the above leaching agent is a hydrophobic organic compound other than unsubstituted alicyclic hydrocarbon compounds and unsubstituted aromatic hydrocarbon compounds. Desirably, the above leaching agent may further contain a hydrogen bond donor.

The hydrogen bond acceptor used in the leaching agent is a component which forms a hydrophobic deep eutectic solvent along with the hydrogen bond donor. The term “deep eutectic solvent” as used in the present specification refers to a solvent in a liquid form at 25° C. which is a mixture including a hydrogen bond donor and a hydrogen bond acceptor, at least one of which is a solid at 25° C. Specifically, the deep eutectic solvent is a liquid at 25° C. even though it includes a substance which is a solid at 25° C. This is because eutectic melting point depression occurs when a hydrogen bond donor is mixed with a hydrogen bond acceptor in a predetermined mixing ratio. Strictly speaking, the deep eutectic solvent differs from an ionic liquid in that it does not consist solely of ions, but includes a hydrogen bond donor. The deep eutectic solvent has an advantage in that it can easily be configured with environmentally-friendly substances as compared with an ionic liquid.

The term “hydrophobic deep eutectic solvent” as used in the present specification refers to a deep eutectic solvent which undergoes phase separation into an aqueous phase and a hydrophobic deep eutectic solvent phase upon contact with water at 25° C. The hydrophobic deep eutectic solvent desirably has a solubility in water at 25° C. of 1 g/100 mL or less, more desirably 0.1 g/100 mL or less, and even more desirably 0.01 g/100 mL or less.

Examples of the hydrogen acceptor used in the leaching agent include halogen salts and the like.

Examples of the halogen salts include quaternary ammonium halides, quaternary phosphonium halides, tertiary ammonium halides, primary ammonium halides.

Examples of the quaternary ammonium halides include choline chloride, tetrabuthylammonium chloride, tetramethylammonium chloride, methyltrioctylammonium chloride, tetraoctylammonium chloride, acetylcholine chloride, chlorocholine chloride, tetraethylammonium bromide, N-(2-hydroxyethyl)-N,N-dimethylbenzene methanaminium chloride, fluorocholine bromide, tetrabutylammonium bromide, and the like.

Examples of the quaternary phosphonium halides include methyltriphenylphosphonium bromide, benzyltriphenylphosphonium chloride, and the like.

Examples of the tertiary ammonium halides include 2-(diethylamino)ethanol hydrochloride.

Examples of the primary ammonium halides include ethylamine hydrochloride.

These can be used alone or in combination of two or more as a hydrogen bond acceptor.

As a hydrogen bond acceptor, quaternary ammonium halides are desired, and tetrabuthylammonium chloride is more desired.

The hydrogen bond acceptor used in the leaching agent has been in contact with hydrochloric acid. Contacting the hydrogen bond acceptor with hydrochloric acid can confer a high ability of leaching nickel on a leaching agent. It is thought that this is because the hydrogen bond acceptor can capture a proton or a chloride ion, or both of them, or hydrochloric acid, so that the leaching agent includes an acid.

The hydrogen bond donor used in the leaching agent is an optional component. In a case where an oxidized ore further includes Mg, Ni can be selectively leached out of Ni, Si, and Mg by allowing the leaching agent to contain a hydrogen bond donor. That is, Ni can be selectively leached into the leaching agent from the oxidized ore containing Ni, Si, and Mg, leaving Si and Mg left behind.

The hydrogen bond donor used in the leaching agent is desirably an acidic hydrogen bond donor. The acidic hydrogen bond donor has a strong ability to release a proton, and it is thought that this contributes to an improved leaching rate of nickel. It should be noted that the phrase “hydrogen bond donor is acidic” as used in the present specification means that the hydrogen bond donor has an acid dissociation constant (pKa) of less than 7. The hydrogen bond donor desirably has an acid dissociation constant (pKa) of 6 or less, more desirably 5 or less. The hydrogen bond donor may have an acid dissociation constant (pKa) of 0 or more, 1 or more, or 2 or more. It should be noted that the “acid dissociation constant (pKa)” as used in the present specification represents a value in water at 25° C., and can be determined by a known method (for example, a method of neutralization titration).

Examples of the acidic hydrogen bond donor include carboxy group-containing compounds. Examples of the carboxy group-containing compounds include fatty acids such as formic acid, acetic acid, butanoic acid, pentanoic acid, hexanoic acid, heptanoic acid, octanoic acid, nonanoic acid, decanoic acid, dodecanoic acid, tetradecanoic acid, pentadecanoic acid, hexadecanoic acid, heptadecanoic acid, octadecanoic acid, eicosanoic acid, docosanoic acid, tetiracosanoic acid, hexacosanoic acid, octacosanoic acid, and triacontanoic acid; polyvalent carboxylic compounds such as oxalic acid, malonic acid, succinic acid, adipic acid, itaconic acid, suberic acid, and 1,2,3-propane tricarboxylic acid; aromatic carboxylic compounds such as benzoic acid; aromatic compounds having a carboxy group-containing substituent, such as phenylacetic acid, 3-phenylpropionic acid, and trans-cinnamic acid; levulinic acid; carboxy group-containing compounds having a hydroxy group, such as lactic acid, tartaric acid, ascorbic acid, citric acid, 4-hydroxybenzoic acid, p-coumaric acid, caffeic acid, and gallic acid; and the like.

These can be used alone or in combination of two or more as a hydrogen bond donor.

As a hydrogen bond donor, desired is a fatty acid, more desired is a fatty acid having 8 to 12 carbon atoms, and even more desired is decanoic acid.

Usually a hydrogen bond donor and a hydrogen bond acceptor in a molar ratio of 2:1 form a deep eutectic solvent. Further, a hydrogen bond acceptor that has made contact with hydrochloric acid even alone has an ability of leaching nickel. Therefore, a molar ratio of a hydrogen bond donor and a hydrogen bond acceptor (hydrogen bond donor:hydrogen bond acceptor) is desirably 3:1 to 1:3, more desirably 2.5:1 to 1:1, and even more desirably 2.1:1 to 2:1.1.

The hydrophobic organic compound used in the leaching agent may be liquid or solid at, for example, 25° C. The hydrogen bond donor and the hydrogen bond acceptor as described above can form a liquid deep eutectic solvent. Therefore, the hydrophobic organic compound can be dissolved in the deep eutectic solvent even if the hydrophobic organic compound is solid. Thereby, a liquid leaching agent can be obtained. When the leaching agent does not include a hydrogen bond donor, the hydrophobic compound is desirably a liquid.

It should be noted that the term “hydrophobic organic compound” as used in the present specification refers to an organic compound having a solubility of 1.0 g/L or less in water at 20° C. The solubility of the hydrophobic organic compound in water at 20° C. is desirably 0.3 g/L or less, more desirably 0.1 g/L or less.

The hydrophobic organic compound may be a saturated organic compound or an unsaturated organic compound. The hydrophobic organic compound may be linear or branched. Examples of the hydrophobic organic compound include hydrocarbon compounds (provided that unsubstituted alicyclic hydrocarbon compounds and unsubstituted aromatic hydrocarbon compounds are excluded), ether compounds, ester compounds, and the like.

Examples of the hydrocarbon compounds to be used include saturated aliphatic hydrocarbon compounds, unsaturated aliphatic hydrocarbon compounds, alicyclic hydrocarbon compounds having a substituent, aromatic hydrocarbon compounds having a substituent, and the like.

Examples of the saturated aliphatic hydrocarbon compounds include n-paraffin-based hydrocarbons such as n-hexane, n-heptane, n-octane, n-nonane, n-decane, n-undecane, n-dodecane, n-tridecane, n-tetradecane, n-pentadecane, n-hexadecane, n-octadecane, n-eicosane; isoparaffin-based hydrocarbons such as isoheptane, isooctane, isononane, isodecane, isoundecane, isododecane, isotridecane, isotetradecane, isopentadecane, isohexadecane, isooctadecane, isoeicosane, and the like. As the saturated aliphatic hydrocarbon compound, those having 6 to 20 carbon atoms are desired, and those having 8 to 18 carbon atoms are more desired.

Examples of the unsaturated aliphatic hydrocarbon compounds include hexene, heptene, octene, nonene, decene, undecene, dodecen, decadiene, undecadiene, dodecadiene, and the like. As the unsaturated aliphatic hydrocarbon compound, those having 6 to 20 carbon atoms are desired, and those having 8 to 18 carbon atoms are more desired.

There is no particular limitation for the number of the substituents of the alicyclic hydrocarbon compounds, but it is desirably 1 to 4. As a substituent, a hydrocarbon group having 1 to 4 carbon atoms is desired, and an alkyl group having 1 to 4 carbon atoms is more desired. Examples of the alicyclic hydrocarbon compounds having a substituent include methylcyclohexane, 4-methyl-1-isopropylcyclohexane, and the like.

There is no particular limitation for the number of the substituents of the aromatic hydrocarbon compounds, but it is desirably 1 to 4. As a substituent, a hydrocarbon group having 1 to 4 carbon atoms is desired, and an alkyl group having 1 to 4 carbon atoms is more desired. Examples of the aromatic hydrocarbon compounds having a substituent include toluene, xylene (for example, o-xylene, m-xylene, p-xylene), ethyltoluene (for example, 2-ethyltoluene, 3-ethyltoluene, 4-ethyltoluene), propylbenzene (for example, n-propylbenzene, cumene, and the like), butylbenzene (for example, n-butylbenzene, sec-butylbenzene, isobutylbenzene, tert-butylbenzene), propyltoluene (for example, 4-propyltoluene, and the like), butyltoluene (for example, 4-sec-butyl-toluene, 4-tert-butyl-toluene, 2-tert-butyl-toluene, and the like), amylbenzene, diethylbenzene, ethylpropylbenzene, trimethylbenzene (for example, 1,2,3-trimethylbenzene, 1,2,4-trimethylbenzene, 1,3,5-trimethylbenzene), tetramethylbenzene (for example, 1,2,3,4-tetramethylbenzene, 1,2,4,5-tetramethylbenzene), ethylxylene (for example, 2-ethyl-p-xylene, 4-ethyl-o-xylene, 5-ethyl-m-xylene, and the like), dimethylpropylbenzene (for example, 2,5-dimethylcumene, 5-isopropyl-m-xylene, and the like), butyldimethylbenzene, diethylmethylbenzene, triethylbenzene, diethylpropylbenzene, allylmethylbenzene (for example, 1-allyl-2-methylbenzene, and the like), methylnaphthalene (for example, 1-methylnaphthalene, 2-methylnaphthalene, and the like), and the like.

The ether compounds are desirably ethers having an alkyl group with 4 or more carbon atoms (desirably 6 to 12 carbon atoms) in view of hydrophobicity. Examples of the ether compounds include dibutyl ether, dipentyl ether, dihexyl ether, diheptyl ether, dioctyl ether, dinonyl ether, didecyl ether, diundecyl ether, didodecyl ether, and the like. As the ether compounds, dialkyl ethers having 8 to 24 carbon atoms are desired, and dialkyl ethers having 12 to 20 carbon atoms are more desired.

Examples of the ester compounds include saturated fatty acid esters such as isopropyl myristate, isopropyl palmitate, octyl palmitate, butyl stearate, and the like. As the ester compounds, saturated fatty acid esters having 15 to 25 carbon atoms are desired.

The hydrophobic organic compounds can be used alone or in combination of two or more. A mixture including two or more of the above substances can also be obtained as commercial products. Examples of these include Swasol 1000 (containing 1,2,4-trimethylbenzene, 1,3,5-trimethylbenzene, cumene, xylene, and the like), Swasol 1500 (containing 1,2,4-trimethylbenzene, naphthalene, and the like), Swasol 1800 (containing methylnaphthalene, 4-tert-butyltoluene, and the like) manufactured by Maruzen Petrochemical Co., Ltd.; Teclean manufactured by ENEOS Corporation (containing naphthene and the like); MC531 manufactured by Tobu Chemical Co., Ltd. (containing isoparaffin and the like); and the like.

The hydrophobic organic compounds desirably include at least one hydrocarbon compound selected from the group consisting of saturated aliphatic hydrocarbon compounds having 6 to 20 carbon atoms, unsaturated aliphatic hydrocarbon compounds having 6 to 20 carbon atoms, alicyclic hydrocarbon compounds having a substituent, aromatic hydrocarbon compounds having a substituent, dialkyl ethers having 8 to 24 carbon atoms, and saturated fatty acid esters having 15 to 25 carbon atoms. When an oxidized ore further includes Mg, the hydrophobic organic compound desirably includes an aromatic hydrocarbon compound having at least one alkyl group with 1 to 4 carbon atoms. This is because Ni can be selectively leached out of Ni, Si and Mg.

There is no particular limitation for the amount of the hydrophobic organic compound in the leaching agent. If the amount of the hydrophobic organic compound is too small, the effect of selective leaching of Ni may become small. If the amount of the hydrophobic organic compound is too large, there is the risk that the leaching speed become lowered. Further, a relatively higher amount of the hydrophobic organic compound can increase the leaching speed of Ni. Therefore, the volume percentage of the hydrophobic organic compound in the leaching agent may be, for example, 5% to 95% by volume, desirably 40% to 95% by volume, more desirably 60% to 90% by volume, even more desirably 70% to 90% by volume, and particularly desirably 80% to 90% by volume.

When the hydrophobic organic compound is used in the leaching agent in addition to the hydrogen bond donor and the hydrogen bond acceptor that has made contact with hydrochloric acid, Ni can be selectively leached from an oxidized ore containing Ni and Si.

This phenomenon is thought to be caused by the interaction of the hydrophobic organic compound with at least one of the hydrogen bond donor, the hydrogen bond acceptor that has made contact with hydrochloric acid, and Si (for example, the hydrophobic organic compound may interact with Si to reduce leaching; the hydrophobic organic compound may interact with at least one of the hydrogen bond donor and hydrogen bond acceptor to prevent leaching of Si; and so on).

The water content of the leaching agent is desirably 2 mass % of less, more desirably 1 mass % or less, and even more desirably 0.5 mass % or less. It should be noted that the water content of the leaching agent can be determined by the Karl Fischer method.

The leaching agent may consist only of a hydrogen bond acceptor that has made contact with hydrochloric acid, and a hydrophobic organic compound. The leaching agent may consist only of a hydrogen bond donor, a hydrogen bond acceptor that has made contact with hydrochloric acid, and a hydrophobic organic compound.

Alternatively, the leaching agent may contain at least one of an unsubstituted alicyclic hydrocarbon compound and an unsubstituted aromatic hydrocarbon compound within a range where the effects of the present disclosure are not significantly interfered. When the leaching agent contains at least one of an unsubstituted alicyclic hydrocarbon compound and an unsubstituted aromatic hydrocarbon compound, the total mass of these hydrocarbon compounds may be desirably 30 mass % or less relative to the mass of the hydrophobic organic compound, more desirably 25 mass % or less, and even more desirably 15 mass % or less.

Alternatively, the leaching agent may contain another component other than these within the range where the effects of the present disclosure are not significantly interfered (for example, within the range of less than 10 mass %, less than 5 mass %, or less than 1 mass % in the leaching agent). Examples of the above another component include reducing agents, oxidizing agents, various additives, and the like.

For example, the leaching agent can be prepared as follows. When a hydrogen bond donor is not used for a leaching agent, a hydrogen bond acceptor is dissolved in a hydrophobic organic compound. The resulting solution of the hydrogen bond acceptor is contacted with hydrochloric acid so as to bring the acid into contact with the hydrogen bond acceptor. Then, the organic phase is collected as the leaching agent.

When a hydrogen bond donor is used for a leaching agent, the hydrogen bond donor is first mixed with a hydrogen bond acceptor to prepare a deep eutectic solvent in accordance with a known method. The hydrogen bond donor and the hydrogen bond acceptor are dry blended, and stirred or kneaded at or above the eutectic point of the deep eutectic solvent to prepare the deep eutectic solvent. Alternatively, the hydrogen bond donor and the hydrogen bond acceptor are dissolved in a solvent, and then the solvent is removed to prepare the deep eutectic solvent.

Next, the deep eutectic solvent is mixed with the hydrophobic organic compound to dissolve the hydrophobic organic compound in the deep eutectic solvent or blend the hydrophobic organic compound with the deep eutectic solvent. The resulting hydrophobic mixture is contacted with hydrochloric acid so as to bring the acid into contact with the hydrogen bond acceptor. Then, the organic phase is collected. Alternatively, the deep eutectic solvent is contacted with hydrochloric acid so as to bring the acid into contact with the hydrogen bond acceptor. The organic phase (that is, the deep eutectic solvent) is then collected, and mixed with the hydrophobic organic compound. Hereinafter, the contact operation with hydrochloric acid will be specifically described.

There is no particular limitation for the concentration of hydrochloric acid. In view of efficiency, a higher concentration of hydrochloric acid is desired. The concentration of hydrochloric acid may be, for example, 0.1 mol/L to 12 mol/L, desirably 3 mol/L to 12 mol/L, more desirably 5 mol/L to 11 mol/L, even more desirably 8 mol/L to 11 mol/L.

When the solution of the hydrogen bond acceptor, the hydrophobic mixture, or the deep eutectic solvent is brought into contact with hydrochloric acid, hydrochloric acid undergoes phase separation from the solution of the hydrogen bond acceptor, the hydrophobic mixture, or the deep eutectic solvent. In view of high efficiency, shaking, stirring, or the like is desirably performed, and shaking is more desired. Shaking, stirring, or the like can be performed using known tools and devices. Therefore, for example, the solution of the hydrogen bond acceptor, the hydrophobic mixture, or the deep eutectic solvent and hydrochloric acid can be added to an acid-resistant container, and shaken with a known shaker or the like to achieve effective contact with the hydrochloric acid.

There is no particular limitation for the contact time between the solution of the hydrogen bond acceptor, the hydrophobic mixture, or the deep eutectic solvent and hydrochloric acid as long as a nickel leaching ability can be given to the leaching agent. The contact time may be appropriately selected depending on contact conditions. The contact time is, for example, 5 minutes to 48 hours, desirably 30 minutes to 24 hours.

Here, the solution of the hydrogen bond acceptor, or the hydrophobic mixture, which is a mixture of the deep eutectic solvent and the hydrophobic organic compound, may be a used leaching agent. The used leaching agent is a leaching agent which has been used at least once to leach nickel from an oxidized ore, for example, an organic phase collected after performing the back-extraction step S202 described below. Contacting the used leaching agent with hydrochloric acid can replenish the leaching agent with protons and halogens to restore the nickel leaching ability of the leaching agent. Thereby, this can prevent the leaching agent from becoming waste. Therefore, the method of leaching nickel from an oxidized ore according to the present disclosure has an advantage in that the leaching agent can be used repeatedly.

The leaching agent can be prepared as described above.

### <Leaching-Agent Contacting Step S102>

In the leaching-agent contacting step S102, an oxidized ore containing Ni and Si is brought into contact with the leaching agent prepared in the leaching-agent preparation step S101. This can preferentially transfer Ni from the oxidized ore to the leaching agent as an organic phase. That is to say, solid-liquid extraction is performed using a special organic phase to preferentially transfer nickel (Ni) from the oxidized ore containing Ni and Si to the organic phase. In another aspect, therefore, the leaching agent according to the present disclosure is the leaching agent as described above.

There is no particular limitation for the oxidized ore used in the leaching-agent contacting step S102 as long as Ni and Si are included. Suitable examples of the oxidized ore include nickel oxidized ores such as limonite ore and saprolite ore. It should be noted that saprolite ore also contains a relatively large amount of Mg.

The oxidized ore may be crushed, classified, or otherwise treated. The particle size of the oxidized ore can be adjusted to a predetermined range (for example, the median diameter D50 of 0.01 to 1000 μm, desirably 1 to 100 μm, as determined by laser diffraction scattering) by crushing treatment, classifying treatment, or the like of the oxidized ore, thereby improving the leaching efficiency. Crushing treatment, classifying treatment, or the like can be performed in accordance with a known method.

There is no particular limitation for the usage amount of the leaching agent relative to an oxidized ore. The usage amount of the leaching agent may be, for example, 10 to 100000 parts by mass, desirably 100 to 10000 parts by mass per 100 parts by mass of an oxidized ore.

Contacting the oxidized ore with the leaching agent can be performed in accordance with a known method. For example, this can be performed by charging a container with the oxidized ore, and then charging the same container with the leaching agent. For example, this can be performed by charging a container with the acid leaching agent, and then charging the same container with the oxidized ore. The leaching agent described above may be prepared in the container into which the oxidized ore is charged so that the preparation of the leaching agent and the contact of the oxidized ore with the leaching agent may be performed simultaneously.

The mixture of the oxidized ore and the leaching agent may be stirred when the oxidized ore is brought into contact with the leaching agent. Stirring can be performed by a known method (for example, such as methods in which a stirring device equipped with a stirrer, stirring blades, and the like are used). Ultrasonic waves may be applied during the contacting the oxidized ore with the leaching agent.

The oxidized ore may be brought into contact with the leaching agent at room temperature (specifically, at 25° C.). In view of increasing the leaching speed, heating may be performed when the oxidized ore is brought into contact with the leaching agent. Heating can be performed in such a way that the container is heated using a known mean, for example, oil bath, mantle heater, bandlike heater (such as ribbon heater), sheet-shaped heater (for example, film heater, silicone rubber heater, and the like), and the like. There is no particular limitation for the heating temperature, but it may be desirably 40° C. or more, more desirably 50° C. or more, and even more desirably 60° C. or more. Meanwhile, in view of energy efficiency, the heating temperature is desirably 100° C. or less, more desirably 80° C. or less, and even more desirably 70° C. or less.

Pressurization may be performed while the oxidized ore is in contact with the leaching agent. Pressurization may be performed in accordance with a known method.

There is no particular limitation for the time of contacting the oxidized ore with the leaching agent, but it may be appropriately selected depending on the components of the leaching agent to be used, the particle size of the oxidized ore, temperature, and the like. The time of contacting the oxidized ore with the leaching agent may be, for example, 1 minute to 100 hours, desirably 1 hour to 50 hours.

After contacting, the organic phase including leached nickel (that is, a nickel leachate) can be collected by a known solid-liquid separation method (for example, filtration).

The method of leaching nickel from an oxidized ore according to the present disclosure can be performed as described above. The method of leaching nickel from an oxidized ore according to the present disclosure enables selective leaching of Ni from an oxidized ore containing Ni and Si. Therefore, Ni can be selectively leached into a nickel leachate, and thus the nickel leachate includes little or no Si. Nickel can be collected from the nickel leachate in accordance with a known method. In the method of manufacturing nickel sulfate according to the present disclosure, nickel is collected as nickel sulfate through the back-extraction step S202.

### <Back-Extraction Step S202>

In the back-extraction step S202, back-extraction is performed using sulfuric acid as an extraction solvent (that is, an aqueous phase). In other words, nickel which has been transferred from the oxidized ore to the leaching agent (that is, an organic phase) is transferred to the aqueous phase. Sulfuric acid can also serve as the source of anion (SO₄²⁻) of nickel sulfate.

There is no particular limitation for the concentration of sulfuric acid as long as nickel can be transferred to an aqueous phase, and it is, for example, 1 mol/L (1 M) or more. Here, the oxidized ore containing Ni and Si may include iron oxide (Fe₂O₃). Therefore, the resulting nickel leachate may be contaminated with Fe. Transfer of Fe into the aqueous phase can be suppressed in the back-extraction step S202 by using a high concentration of sulfuric acid. That is, nickel sulfate which is less contaminated with ferrous components can be obtained. In view of the above, the concentration of sulfuric acid is desirably 1.5 mol/L or more, more desirably 2 mol/L or more, even more desirably 2.5 mol/L or more, and most desirably 3 mol/L or more. There is no particular limitation for the upper limit of the concentration of sulfuric acid, but it may be determined by technical limitation. The concentration of sulfuric acid may be 15 mol/L or less, 10 mol/L or less, 7.5 mol/L or less, or 5 mol/L or less.

An extraction solvent (that is, an aqueous phase) may contain a component other than sulfuric acid within the range where the effects of the present disclosure are not significantly interfered (for example, less than 10 mass %, less than 5 mass %, or less than 1 mass %).

There is no particular limitation for the usage amount of sulfuric acid relative to the nickel leachate. Leachate:sulfuric acid (by volume ratio) may be, for example, 1:0.05 to 20, desirably 1:0.2 to 5.

Back-extraction may be performed in accordance with a known method. After performing back-extraction, a solution containing nickel sulfate can be obtained by collecting the aqueous phase. Nickel sulfate can be obtained by crystallizing and recovering nickel sulfate from the solution containing nickel sulfate in accordance with a known method.

Depending on the application of nickel sulfate, nickel sulfate may be collected in a form of an aqueous solution without precipitating nickel sulfate from the solution containing nickel sulfate. At this time, the solution containing nickel sulfate may be used as is for the desired application, or it may be neutralized or otherwise treated before use.

In this way, Ni can be selectively leached from the oxidized ore containing Ni and Si, and nickel sulfate can be manufactured. In the above manufacturing method, nickel sulfate can be manufactured simply by performing the nickel leaching step S201 and the back-extraction step S202. Accordingly, the above manufacturing method requires fewer steps and, in addition to that, is simpler to operate. Further, the organic phase collected after performing the back-extraction step S202 can be recycled in the method of leaching nickel from an oxidized ore according to the present disclosure and the method of manufacturing nickel sulfate according to the present disclosure by performing the leaching-agent preparation step S101 where it is contacted with hydrochloric acid. This can reduce the amount of waste to be generated. Therefore, the present method of manufacturing nickel sulfate is a method which generates a less amount of waste, and can be simply performed.

Furthermore, nickel sulfate is mainly used as a source of nickel for cathode active materials of lithium-ion secondary batteries. Therefore, the above method of manufacturing nickel sulfate has high industrial value as a new method for securing nickel sulfate as a source of nickel for cathode active materials of lithium-ion secondary batteries.

### EXAMPLES

Although Examples of the present disclosure will be described below, these are not intended to limit the present disclosure to those shown in such Example.

### Comparative Example 1

Decanoic acid (decA) as a hydrogen bond donor was mixed with trioctylmethylammonium chloride (TOMAC) as a hydrogen bond acceptor at a volume ratio of 2:1 to prepare a deep eutectic solvent. To this deep eutectic solvent, 10 mol/L of hydrochloric acid was added at a volume ratio of 1:1, and shaken for 1 hour. Then, the organic phase was extracted to obtain a leaching agent. Then, 200 mg of a nickel oxidized ore (that is, saprolite) per 20 mL of this leaching agent was added, and leaching was performed at 60° C. for 24 hours with stirred at 400 rpm. Then, the leachate was collected and analyzed for determining the leaching rates of Ni and Si. Results are shown in Table 1.

### Comparative Example 2

To Swasol 1800 (aromatic high-boiling-point solvent) manufactured by Maruzen Petrochemical Co., Ltd., 10 mol/L of hydrochloric acid was added at a volume ratio of 1:1, and shaken for 1 hour. Then, the organic phase was extracted to obtain a leaching agent. This leaching agent was used to perform leaching and analysis as in Comparative Example 1. Results are shown in Table 1.

### Example 1

TOMAC was mixed with toluene at a volume ratio of 1:1. To the resulting mixture, 10 mol/L of hydrochloric acid was added at a volume ratio of 1:1, and shaken for 1 hour. Then, the organic phase was extracted to obtain a leaching agent. This leaching agent was used to perform leaching and analysis as in Comparative Example 1. Results are shown in Table 1.

### Example 2

TOMAC was mixed with Swasol 1800 at a volume ratio of 1:1. To the resulting mixture, 10 mol/L of hydrochloric acid was added at a volume ratio of 1:1, and shaken for 1 hour. Then, the organic phase was extracted to obtain a leaching agent. This leaching agent was used to perform leaching and analysis as in Comparative Example 1. Results are shown in Table 1.

### Example 3

A deep eutectic solvent is prepared by mixing decA as a hydrogen bond donor with TOMAC as a hydrogen bond acceptor at a volume ratio of 2:1. This deep eutectic solvent was mixed with toluene at a volume ratio of 1:1. To the resulting mixture, 10 mol/L of hydrochloric acid was added at a volume ratio of 1:1, and shaken for 1 hour. Then, the organic phase was extracted to obtain a leaching agent. This leaching agent was used to perform leaching and analysis as in Comparative Example 1. Results are shown in Table 1.

### Comparative Example 3

An extraction agent was obtained as in Example 3 except that naphthalene was used instead of toluene. This leaching agent was used to perform leaching and analysis as in Comparative Example 1. Results are shown in Table 1.

### Example 4

An extraction agent was obtained as in Example 3 except that methylnaphthalene was used instead of toluene. This leaching agent was used to perform leaching and analysis as in Comparative Example 1. Results are shown in Table 1.

### Example 5

An extraction agent was obtained as in Example 3 except that 4-tert-butyltoluene was used instead of toluene. This leaching agent was used to perform leaching and analysis as in Comparative Example 1. Results are shown in Table 1.

### Example 6

An extraction agent was obtained as in Example 3 except that Swasol 1800 was used instead of toluene. This leaching agent was used to perform leaching and analysis as in Comparative Example 1. Results are shown in Table 1.

### Comparative Example 4

An extraction agent was obtained as in Example 3 except that Teclean manufactured by ENEOS Corporation (naphthene-based synthetic hydrocarbon) was used instead of toluene. This leaching agent was used to perform leaching and analysis as in Comparative Example 1. Results are shown in Table 1.

### Example 7

An extraction agent was obtained as in Example 3 except that MC531 manufactured by Tobu Chemical Co., Ltd. (main component: isoparaffin) was used instead of toluene. This leaching agent was used to perform leaching and analysis as in Comparative Example 1. Results are shown in Table 1.

### Example 8

A deep eutectic solvent was prepared by mixing decA as a hydrogen bond donor with TOMAC as a hydrogen bond acceptor at a volume ratio of 2:1. This deep eutectic solvent was mixed with Swasol 1800 at a volume ratio of 1:4. To the resulting mixture, 10 mol/L of hydrochloric acid was added at a volume ratio of 1:1, and shaken for 1 hour. Then, the organic phase was extracted to obtain a leaching agent. This leaching agent was used to perform leaching and analysis as in Comparative Example 1. Results are shown in Table 1.

### Example 9

An extraction agent was obtained as in Example 8 except that the deep eutectic solvent was mixed with Swasol 1800 at a volume ratio of 1:3. This leaching agent was used to perform leaching and analysis as in Comparative Example 1. Results are shown in Table 1.

### Example 10

An extraction agent was obtained as in Example 8 except that isopropyl myristate was used instead of Swasol 1800. This leaching agent was used to perform leaching and analysis as in Comparative Example 1. Results are shown in Table 1.

### Example 11

An extraction agent was obtained as in Example 3 except that isopropyl myristate was used instead of toluene. This leaching agent was used to perform leaching and analysis as in Comparative Example 1. Results are shown in Table 1.

### Example 12

An extraction agent was obtained as in Example 3 except that dioctyl ether was used instead of toluene. This leaching agent was used to perform leaching and analysis as in Comparative Example 1. Results are shown in Table 1.

### Example 13

An extraction agent was obtained as in Example 3 except that 1-dodecene was used instead of toluene. This leaching agent was used to perform leaching and analysis as in Comparative Example 1. Results are shown in Table 1.

TABLE 1

| | Leaching agent | | | | | |
|---|---|---|---|---|---|---|
| | Hydrogen | Hydrogen | Hydrophobic | | Leaching rate | |
| | bond | bond | organic | | (mass %) | |
| | donor | acceptor | compound | Amount | Ni | Si |
| Comparative | decA | TOMAC | | | 15.0 | 5 |
| Example 1 | | | | | | |
| Comparative | — | — | Swasol | — | 0.2 | 0 |
| Example 2 | | | | | | |
| Example 1 | — | TOMAC | toluene | equal | 10.5 | 0 |
| | | | | ratio | | |
| Example 2 | — | TOMAC | Swasol | equal | 12.8 | 0 |
| | | | | ratio | | |
| Example 3 | decA | TOMAC | toluene | equal | 9.0 | 0 |
| | | | | ratio | | |
| Comparative | decA | TOMAC | naphthalene | equal | 7.5 | 10 |
| Example 3 | | | | ratio | | |
| Example 4 | decA | TOMAC | methylnaphthalene | equal | 12.8 | 0 |
| | | | | ratio | | |
| Example 5 | decA | TOMAC | 4-tert-butyltoluene | equal | 8.3 | 0 |
| | | | | ratio | | |
| Example 6 | decA | TOMAC | Swasol | equal | 15.0 | 0 |
| | | | | ratio | | |
| Comparative | decA | TOMAC | Teclean | equal | 10.0 | 3 |
| Example 4 | | | | ratio | | |
| Example 7 | decA | TOMAC | MC531 | equal | 10.0 | 0 |
| | | | | ratio | | |
| Example 8 | decA | TOMAC | Swasol | 4 times | 98.0 | 0 |
| Example 9 | decA | TOMAC | Swasol | 3 times | 97.2 | 0 |
| Example 10 | decA | TOMAC | isopropyl myristate | 4 times | 92.0 | 0.45 |
| Example 11 | decA | TOMAC | isopropyl myristate | equal | 11.0 | 0 |
| | | | | ratio | | |
| Example 12 | decA | TOMAC | dioctyl ether | equal | 12.2 | 0 |
| | | | | ratio | | |
| Example 13 | decA | TOMAC | 1-dodecene | equal | 13.1 | 0 |
| | | | | ratio | | |

In Comparative Example 1, leaching was performed with the deep eutectic solvent alone. As a result, 5 mass % of Si was leached along with Ni. In Comparative Example 2, the hydrophobic organic compound alone was used as a leaching agent. The results in Table 1 show that the hydrophobic organic compound itself has no leaching ability.

In contrast, as the results from Examples 1 to 13 shown in Table 1, Ni can be selectively leached from the saprolite containing Ni and Si by using a liquid leaching agent containing a hydrogen bond acceptor that has made contact with hydrochloric acid and a hydrophobic organic compound. However, the results from Comparative Examples 3 and 4 show that Si is also leached when the hydrophobic organic compound is an unsubstituted alicyclic hydrocarbon compound or an unsubstituted aromatic hydrocarbon compound.

Therefore, the above results demonstrate that the method of leaching nickel from an oxidized ore according to the present disclosure can selectively leach Ni from an oxidized ore containing Ni and Si.

Although specific examples of the present disclosure are described above, these are merely illustrative, and are not intended to limit the scope of the claims. Various modifications and alternations can be made on the specific examples illustrated above, and these will also be fallen into the scope of the claims.

That is, the method of leaching nickel from an oxidized ore according to the present disclosure, the method of manufacturing nickel sulfate according to the present disclosure, and the nickel-leaching agent according to the present disclosure are as described in the following items [1] to [11].

[1] A method of leaching nickel from an oxidized ore, the method including the steps of:
preparing a liquid leaching agent containing a hydrogen bond acceptor that has made contact with hydrochloric acid, and a hydrophobic organic compound (provided that unsubstituted alicyclic hydrocarbon compounds and unsubstituted aromatic hydrocarbon compounds are excluded); and
contacting an oxidized ore containing nickel and silicon with the leaching agent.
   [2] The method according to item [1], wherein the hydrophobic organic compound includes at least one compound selected from the group consisting of saturated aliphatic hydrocarbon compounds having 6 to 20 carbon atoms, unsaturated aliphatic hydrocarbon compounds having 6 to 20 carbon atoms, alicyclic hydrocarbon compounds having a substituent, aromatic hydrocarbon compounds having a substituent, dialkyl ethers having 8 to 24 carbon atoms, and saturated fatty acid esters having 15 to 25 carbon atoms.
   [3] The method according to item [1], wherein the hydrophobic organic compound includes an aromatic hydrocarbon compound having at least one alkyl group with 1 to 4 carbon atoms.
   [4] The method according to any one of items [1] to [3], wherein the leaching agent further contains a hydrogen bond donor.
   [5] The method according to item [4], wherein the hydrogen bond donor is a carboxy-group containing compound, and the hydrogen bond acceptor is a halide salt.
   [6] The method according to item [4], wherein the hydrogen bond donor is a fatty acid, and the hydrogen bond acceptor is a quaternary ammonium halide.
   [7] The method according to any one of items [1] to [6], wherein the volume percentage of the hydrophobic organic compound in the leaching agent is 5% to 95% by volume.
   [8] The method according to any one of items [1] to [6], wherein the volume percentage of the hydrophobic organic compound in the leaching agent is 70% to 90% by volume.
   [9] A liquid nickel-leaching agent, including a hydrogen bond acceptor that has made contact with hydrochloric acid, and a hydrophobic organic compound.
   [10] A method of manufacturing nickel sulfate, the method including the steps of:
obtaining a nickel leachate by the method according to any one of items [1] to [8]; and
back-extracting the nickel leachate using sulfuric acid to obtain an aqueous phase containing nickel sulfate.
   [11] The method of manufacture according to item [10], wherein the concentration of sulfuric acid is 2 mol/L or more in the step of obtaining the aqueous phase.

What is claimed is:

1. A method of leaching nickel from an oxidized ore, the method comprising the steps of:
preparing a liquid leaching agent containing a hydrogen bond acceptor that has made contact with hydrochloric acid, and a hydrophobic organic compound (provided that unsubstituted alicyclic hydrocarbon compounds and unsubstituted aromatic hydrocarbon compounds are excluded); and
contacting an oxidized ore containing nickel and silicon with the leaching agent.

2. The method according to claim 1, wherein the hydrophobic organic compound includes at least one compound selected from the group consisting of saturated aliphatic hydrocarbon compounds having 6 to 20 carbon atoms, unsaturated aliphatic hydrocarbon compounds having 6 to 20 carbon atoms, alicyclic hydrocarbon compounds having a substituent, aromatic hydrocarbon compounds having a substituent, dialkyl ethers having 8 to 24 carbon atoms, and saturated fatty acid esters having 15 to 25 carbon atoms.

3. The method according to claim 1, wherein the hydrophobic organic compound includes an aromatic hydrocarbon compound having at least one alkyl group with 1 to 4 carbon atoms.

4. The method according to claim 1, wherein the leaching agent further contains a hydrogen bond donor.

5. The method according to claim 4, wherein the hydrogen bond donor is a carboxy-group containing compound, and the hydrogen bond acceptor is a halide salt.

6. The method according to claim 4, wherein the hydrogen bond donor is a fatty acid, and the hydrogen bond acceptor is a quaternary ammonium halide.

7. The method according to claim 1, wherein the volume percentage of the hydrophobic organic compound in the leaching agent is 5% to 95% by volume.

8. The method according to claim 1, wherein the volume percentage of the hydrophobic organic compound in the leaching agent is 70% to 90% by volume.

9. A liquid nickel-leaching agent, comprising a hydrogen bond acceptor that has made contact with hydrochloric acid, and a hydrophobic organic compound.

10. A method of manufacturing nickel sulfate, the method comprising the steps of:
obtaining a nickel leachate by the method according to claim 1; and
back-extracting the nickel leachate using sulfuric acid to obtain an aqueous phase containing nickel sulfate.

11. The method of manufacture according to claim 10, wherein the concentration of sulfuric acid is 2 mol/L or more in the step of obtaining the aqueous phase.
